(19) United States
(12) Patent Application Publication
(10) Pub. No.: US 2019/0095944 A1
(43) Pub. Date: Mar. 28, 2019

(54) SELECTING A CONTENT ITEM FOR PRESENTATION TO A USER OF AN ONLINE SYSTEM AT A CONTENT PUBLISHER BASED ON A GUARANTEED NUMBER OF IMPRESSIONS OF THE CONTENT ITEM

(71) Applicant: Facebook, Inc., Menlo Park, CA (US)

(72) Inventors: Christopher Michael Hahn, London (GB); Alan Joseph Cheilek, London (GB); Bogdan Victor Titiu, London (GB); Michael Duan Zhou, Sammamish, WA (US)

(21) Appl. No.: 15/716,841

(22) Filed: Sep. 27, 2017

(51) Int. Cl. G06Q 30/02

(52) U.S. Cl. CPC G06Q 30/0243; G06Q 30/0272; G06Q 30/0269; G06Q 30/0277; G06Q 30/0246

(57) ABSTRACT

An online system communicates information describing deals guaranteeing impressions of content items within specified time periods to a content publisher at which the content items may be presented. The online system receives information describing an assignment of each deal to a placement position within a website for the content publisher. Upon receiving a request to present a content item to a viewing user of the online system at a placement position, the online system identifies candidate content items associated with deals assigned to the placement position, in which the candidate content items are associated with targeting criteria satisfied by the viewing user. Based at least in part on a number of impressions achieved by each candidate content item in relation to a number of impressions guaranteed for the candidate content item, the online system selects a candidate content item for presentation to the viewing user at the placement position.

### BACKGROUND

This disclosure relates generally to online systems, and more specifically to selecting a content item for presentation to a user of an online system at a content publisher based on a guaranteed number of impressions of the content item.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for users to share content by creating content items (e.g., advertisements) for presentation to additional online system users. For example, users may share photos or videos they have uploaded by creating content items that include the photos or videos that are presented to additional users to whom they are connected in the online system. By allowing users to create content items for presentation to additional online system users, an online system also provides abundant opportunities to persuade additional online system users to take various actions and/or to increase awareness about products, services, opinions, or causes among online system users. For example, if a user of the online system who volunteers for a non-profit organization creates a content item encouraging additional online system users to volunteer for the non-profit organization, the online system may present the content item to these additional online system users.

Conventionally, online systems generate revenue by displaying content to their users. For example, an online system may charge an advertiser for each presentation of an advertisement to an online system user (i.e., each “impression”) or for each interaction with an advertisement by an online system user (e.g., each click on the advertisement, each purchase made as a result of clicking through the advertisement, etc.). Furthermore, by presenting content that encourages user engagement with online systems, online systems may increase the number of opportunities they have to generate revenue. For example, if an online system user scrolls through a newsfeed to view content that captures the user's interest, advertisements that are interspersed in the newsfeed also may be presented to the user.

To encourage user engagement with online systems, online systems may select content items for presentation to online system users based on targeting criteria associated with the content items that identify users who are likely to have an interest in the content items. For example, if a content item is associated with bakeware, targeting criteria associated with the content item may identify online system users who are likely to have an interest in bakeware (e.g., online system users whose hobbies include baking, online system users whose professions are associated with baking, etc.). In this example, upon identifying an opportunity to present content to a user of the online system, the online system may select the content item for presentation to the user if attributes for the user satisfy one or more targeting criteria associated with the content item.

Furthermore, online systems may provide various offers or services to encourage online system users to provide content items for presentation to additional online system users. In some instances, an online system may offer a “direct sell” of a content item, in which the online system makes a guarantee associated with the content item. For example, an online system may guarantee that a certain number of impressions of a content item will be achieved within a specified time period. Furthermore, to expose content items to larger audiences, online systems also may offer to provide content items to third-party content publishers, which may present the content items to individuals who visit websites for these content publishers.

However, online systems may find it difficult to integrate various offers and services while selecting content items for presentation to online system users that are likely to be relevant to the users. For example, if an online system offers direct selling services and provides content items that are the subject of guarantees to third-party content publishers, the online system may find it risky to rely on the content publishers to fulfill the guarantees associated with the content items since the content publishers have no obligation to do so. Therefore, in this example, impressions achieved by the content items presented by the content publishers may be excluded from the number of impressions guaranteed for the content items. Furthermore, in this example, the third-party content publishers also may be unable to select content items for presentation to online system users based on targeting criteria associated with the content items unless the online system also provides personal information for its users to the content publishers, which may raise privacy concerns.

### SUMMARY

An online system, such as an online advertising system, offers a “direct sell” of a content item (e.g., an advertisement) to a content-providing user of the online system (e.g., an individual or an entity that provides photos, videos, advertisements, or other content to the online system), in which the online system makes a deal with the content-providing user guaranteeing a number of impressions of the content item within a specified time period. For example, the online system may guarantee a content-providing user of the online system who is an advertiser that 1,000 impressions of an advertisement will be achieved within a period of one month. In some embodiments, a direct sell offered by the online system also may guarantee a number of actions associated with a content item (e.g., a guaranteed number of clicks on the content item, a guaranteed number of conversions associated with the content item, etc.) within a specified time period.

A deal between the online system and a content-providing user may be associated with various types of information. Examples of information associated with a deal may include information identifying a content-providing user with whom the online system has made the deal, a value associated with the deal provided by the content-providing user (e.g., a budget), a content item associated with the content-providing user that is the subject of the deal, targeting criteria associated with the content item that specify attributes for online system users who are eligible to be presented with the content item, a value associated with each impression of the content item/each action associated with the content item (e.g., an amount charged to the content-providing user for each impression/action), and a guarantee associated with the content item (e.g., a guaranteed number of impressions of the content item or a guaranteed number of actions associated with the content item within a specified time period). For example, if a deal is made between the online system and a content-providing user who is an advertiser, the deal may be associated with a budget provided by the advertiser, an advertisement received from the advertiser, targeting criteria associated with the advertisement, an amount charged to the advertiser for each impression of the advertisement, and a guaranteed number of impressions of the advertisement within a time period specified by the advertiser.

The online system may communicate information describing deals between the online system and various content-providing users of the online system to various content publishers at which the content items associated with the deals may be presented to viewing users of the online system. A content publisher may present content items to viewing users of the online system in various placement positions within web pages of a website for the content publisher, in which the placement positions have been designated by the content publisher for the presentation of content items. Examples of placement positions within a web page may include positions in a right rail or in a left rail of the web page, rotating positions within a scrollable content unit presented at the top or at the bottom of the web page, positions distributed within an area of the web page where primary content (e.g., the text of an article) may be presented, etc. In some embodiments, a content publisher may assign a placement position identifier to each placement position within a website for the content publisher, in which each placement position identifier uniquely identifies each placement position within the website. For example, each placement position within a website for a content publisher may be associated with a different identification number that corresponds to a placement position identifier.

The online system may receive information associated with placement positions within a website for a content publisher. For example, the online system may receive information from a content publisher describing a number of placement positions within a website for the content publisher, a placement position identifier associated with each placement position, and a location of each placement position relative to other objects within the website (e.g., tracking mechanisms embedded into web pages of the website). In some embodiments, the online system may store information describing each placement position associated with a content publisher in association with information identifying the content publisher (e.g., a name of the content publisher, a username or a user identification number associated with the content publisher, etc.).

A content publisher may embed tracking mechanisms, such as tracking pixels, into content items presented by the content publisher, in which the tracking mechanisms are configured to communicate information to the online system that describes requests received from various individuals to be presented with the content items (i.e., impressions of the content items). In some embodiments, information describing a request to be presented with a content item may include user-identifying information for an individual from whom the request was received. User-identifying information may include personally identifiable information, such as a full name, a home address, a phone number, an email address, a user identifier that is unique to an individual in the online system (e.g., a username, a user identification number, or a cookie identifier), a client device identifier (e.g., an IP address), a browser identifier (e.g., a user agent), etc. For example, when an individual requests to be presented with a content item in a web page of a website for a content publisher, a tracking pixel that is embedded into the content item may communicate information to the online system that identifies the content item, the web page and/or the website, the content publisher associated with the web page/website, a client device from which the request was received (e.g., a client device identifier associated with the individual, etc.), and a time at which the request was received. In embodiments in which the online system receives information describing requests received from individuals to be presented with content items by various content publishers, the online system may store information describing each request. For example, the online system may keep track of each request received from an individual to be presented with a content item as an impression achieved by the content item.

In various embodiments, a content publisher also may embed tracking mechanisms into web pages of a website for the content publisher, in which the tracking mechanisms are configured to communicate information to the online system that describes requests received from various individuals to access the web pages. Similar to information describing a request to be presented with a content item, in some embodiments, information describing a request to access a web page may include user-identifying information for an individual from whom the request was received. For example, when an individual requests to access a web page of a website for a content publisher, a tracking pixel that is embedded into the web page may communicate information to the online system that identifies the content publisher associated with the web page, the web page that was requested, a client device from which the request was received (e.g., a cookie identifier previously stored in the client device by the online system, etc.), and a time at which the request was received. Also similar to information describing a request to be presented with a content item, in some embodiments, the online system also may store information describing each request to access a web page of a website for a content publisher.

Based on information describing requests from various individuals to access a website for a content publisher received via one or more tracking mechanisms embedded into one or more web pages of the website, the online system may identify online system users included among the individuals. In some embodiments, the online system may identify online system users included among the individuals by comparing user-identifying information for the individuals to user-identifying information maintained in the online system for users of the online system. For example, suppose that the online system receives information describing a request from an individual to access a web page of a website for a content publisher via a tracking pixel embedded into the web page, in which the information includes a client device identifier associated with the individual. In this example, the online system may compare the client device identifier associated with the individual to client device identifiers maintained in the online system for various online system users. Continuing with this example, the online system may identify the individual as an online system user if the client device identifier associated with the individual matches a client device identifier associated with the online system user.

Once the online system has identified online system users included among individuals who have requested to access a website for a content publisher, the online system may retrieve various attributes for the online system users. Examples of attributes for an online system user include demographic information for the user (e.g., age, gender, etc.), interests or hobbies of the user, information describing actions previously performed by the user (e.g., clicks on various content items) in the online system or in a third-party system, or any other suitable characteristic that may be associated with the user. The online system may retrieve attributes for online system users who have requested to access a website for a content publisher by retrieving information maintained in the online system describing a set of attributes for each unique online system user who has requested to access the website. For example, if the online system has identified each online system user included among individuals who have requested to access a website for a content publisher, the online system may retrieve a set of attributes stored in association with a user profile of each user maintained in the online system. In some embodiments, the online system may use the attributes for online system users who have requested to access a website for a content publisher to predict an audience inventory associated with one or more deals, as described below.

Once the online system has communicated information to a content publisher describing one or more deals between the online system and one or more content-providing users of the online system, the content publisher may assign the deal(s) to placement positions within web pages of a website for the content publisher. In embodiments in which a content publisher assigns a placement position identifier to each placement position, each deal assigned to a placement position may be associated with a placement position identifier assigned to the placement position. Information describing one or more deals assigned to a placement position, may be communicated to the online system by a content publisher. For example, a content publisher may communicate information to the online system describing a deal between the online system and a content-providing user, in which the online system guarantees the content-providing user a number of impressions of a content item within a time period of one month. In this example, the content publisher also may communicate information to the online system indicating that the deal is assigned to a placement position within a website for the content publisher, in which the placement position is identified by a placement position identifier assigned to the placement position. The online system may store information describing assignments of deals to placement positions within a website for a content publisher in association with information identifying the content publisher. In the above example, the online system may store the information describing the deal and the placement position identifier in association with a name or an identification number associated with the content publisher.

In some embodiments, based at least in part on information describing deals assigned to placement positions within a website for a content publisher, information describing the placement positions, and information received via one or more tracking mechanisms embedded into the website, the online system may predict an audience inventory associated with each deal. For example, suppose that the online system receives information associated with a deal from a content publisher, in which the deal has been assigned to a placement position within a website for the content publisher and guarantees 100 impressions of a content item within one month and targeting criteria associated with the content item identify individuals who are at least 21 years old who live in New York. In this example, to predict an audience inventory associated with the deal, the online system may identify a tracking mechanism embedded into a web page in which the placement position is located and retrieve historical data received via the tracking mechanism. Continuing with this example, based on the historical data, the online system may predict an audience inventory associated with the deal by determining a number of requests to access the web page over a period of one month received from online system users who are at least 21 years old and who live in New York. In some embodiments, the online system also may predict an audience inventory associated with a deal by determining a number of requests to access a web page of a website for a content publisher received from unique users of the online system. In the above example, the online system may not count multiple requests to access the web page received from the same online system user when predicting the audience inventory associated with the deal. In various embodiments, once the online system has predicted an audience inventory associated with a deal, the online system may store the predicted audience inventory.

In some embodiments, once the online system has predicted an audience inventory associated with a deal, the online system may generate a user interface based on the prediction. For example, the online system may generate a user interface that indicates that an audience inventory predicted for a deal includes a particular number of online system users. In various embodiments, the user interface generated by the online system may include an impression opportunity curve associated with a placement position to which a deal has been assigned. In such embodiments, the impression opportunity curve may indicate a number of visits by online system users to a web page including the placement position over a period of time, such that each visit may correspond to an impression achieved by a content item presented in the placement position. For example, the online system may determine a number of requests to access a web page of a web site for a content publisher at various times received from online system users who have attributes that satisfy targeting criteria associated with a particular deal assigned to a placement position within the web page. In this example, based on the number of requests, the online system may generate a user interface that includes an impression opportunity curve associated with the placement position that indicates a number of impression opportunities the content publisher will have to present a content item that is the subject of the deal assigned to the placement position over a period of time. In various embodiments, an impression opportunity curve associated with a placement position to which a deal has been assigned may correspond to any type of curve that indicates a number of impression opportunities a content publisher will have to present a content item that is the subject of a deal assigned to the placement position over a period of time. For example, an impression opportunity curve may correspond to an integrated curve (e.g., a cumulative sum of a number of visits by online system users to a web page during each hour of a day, ranging from zero to one).

In various embodiments, the online system also may determine additional values based on a predicted audience inventory associated with a deal. For example, suppose that the online system predicts an audience inventory of 300 users associated with a deal, in which the online system has guaranteed 200 impressions of a content item associated with the deal within one month and that the content publisher has presented the content item to 70 different users in the first two weeks of the month. In this example, the online system may determine that of the 200 impressions guaranteed by the online system, if 100 have been achieved by 70 users in the predicted audience inventory, there are 230 users remaining in the predicted audience inventory who may achieve the remaining 100 impressions guaranteed by the online system. In various embodiments, the online system may communicate a predicted audience inventory associated with a deal, diagrams associated with the deal, and/or additional values determined based on the predicted audience inventory associated with the deal to a content-providing user of the online system with whom the online system has made the deal and/or to a content publisher that has assigned the deal to a placement position within a website for the content publisher.

Upon receiving a request from a content publisher to present a content item to a viewing user of the online system at a placement position within a website for the content publisher, the online system may identify a set of candidate content items eligible to be presented to the viewing user based on information identifying the placement position and user-identifying information for the viewing user included in the request. The online system may identify one or more deals assigned to the placement position specified in the request received from the content publisher and a content item associated with each deal. For example, based on a placement position identifier received in a request from a content publisher to present a content item to a viewing user of the online system, the online system may identify multiple deals assigned to the placement position identified by the placement position identifier. In this example, the online system may then identify a content item that is the subject of each deal. The online system also may retrieve a set of attributes associated with the viewing user based on the user-identifying information for the viewing user included in the request. For example, based on a username or an IP address associated with the viewing user, the online system may identify the viewing user and retrieve a set of attributes for the viewing user stored in association with a user profile of the viewing user. Of the content items associated with deals assigned to the placement position, the online system may identify the set of candidate content items as the content items that are associated with targeting criteria satisfied by attributes for the viewing user of the online system.

For each candidate content item identified by the online system, the online system may compute an achievement value associated with the candidate content item indicating a number of impressions/actions achieved by the candidate content item in relation to a number of impressions/actions guaranteed for the candidate content item. For example, if a candidate content item has achieved 20 impressions and the online system has guaranteed 100 impressions of the candidate content item, the online system may compute an achievement value for the candidate content item corresponding to a percentage indicating that 20% of the guaranteed impressions have been achieved by the candidate content item. Alternatively, in the above example, the achievement value computed by the online system may correspond to a ratio (e.g., 1:5 or 1/5) associated with the candidate content item, indicating that one out of five of the guaranteed impressions have been achieved by the candidate content item.

In some embodiments, achievement values associated with candidate content items also may be computed based at least in part on additional information associated with guarantees associated with the candidate content items. In one embodiment, an achievement value associated with a candidate content item is computed based at least in part on an amount of time remaining for its associated guarantee to be satisfied. For example, suppose that the online system determines that 30% of the impressions guaranteed by the online system for a first and a second candidate content item have been achieved. In this example, if one week remains for the first candidate content item to achieve the remaining 70% of its impressions and four weeks remain for the second candidate content item to achieve the remaining 70% of its impressions, the online system may associate a weight with each candidate content item that is proportional to the number of weeks remaining, such that a lower weight is associated with the first candidate content item than with the second candidate content item since less time remains for the first candidate content item to satisfy its associated guarantee than for the second candidate content item to satisfy its associated guarantee.

In another embodiment, an achievement value associated with a candidate content item also may be computed based at least in part on a number of guaranteed impressions/actions yet to be achieved. For example, if 10 impressions are guaranteed for a first candidate content item while 1,000 impressions are guaranteed for a second candidate content item and each candidate content item has achieved 25% of its guaranteed impressions, the online system may associate weights with the candidate content items that are inversely proportional to the number of impressions remaining, such that a lower weight is associated with the second candidate content item than with the first candidate content item since a greater number of impressions need to be achieved for the second candidate content item to satisfy its associated guarantee than for the first candidate content item to satisfy its associated guarantee.

In yet another embodiment, an achievement value associated with a candidate content item also may be computed based at least in part on a number of users remaining in an audience inventory predicted for a deal associated with the candidate content item who may satisfy a guarantee associated with the candidate content item. For example, suppose that the online system determines that 500 users remain in an audience inventory predicted for a first deal and 400 users remain in an audience inventory predicted for a second deal, in which the online system has guaranteed 300 impressions of a candidate content item associated with each deal within one month. In this example, the online system may associate a weight with each candidate content item that is proportional to the number of users remaining in the audience inventory predicted for each deal. Continuing with this example, the online system associates a lower weight with the second candidate content item than with the first candidate content item since fewer users remain for the second candidate content item to satisfy its associated guarantee than for the first candidate content item to satisfy its associated guarantee. In embodiments in which the online system associates a weight with a candidate content item, the online system may compute an achievement value associated with the candidate content item based at least in part on the weight.

Once the online system has computed an achievement value associated with each candidate content item, the online system may select a candidate content item based at least in part on the achievement values and send the selected content item to the content publisher for presentation to the viewing user of the online system at the placement position. For example, the online system may rank the candidate content items based at least in part on an achievement value associated with each candidate content item and select the candidate content item having the highest rank for presentation to a viewing user of the online system. In this example, the online system may then send the selected content item to a content publisher from which a request to present a content item to the viewing user was received. Once the content publisher receives the content item selected by the online system, the content publisher may present the content item to the viewing user at the placement position.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for selecting a content item for presentation to a user of an online system at a content publisher based on a guaranteed number of impressions of the content item, in accordance with an embodiment.

FIG. 4 is an example of placement positions within a web page of a website for a content publisher, in accordance with an embodiment.

FIG. 5 is an example of information describing deals assigned to placement positions within one or more websites for one or more content publishers, in accordance with an embodiment.

FIG. 6 is an example user interface generated based on an audience inventory predicted for a deal, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

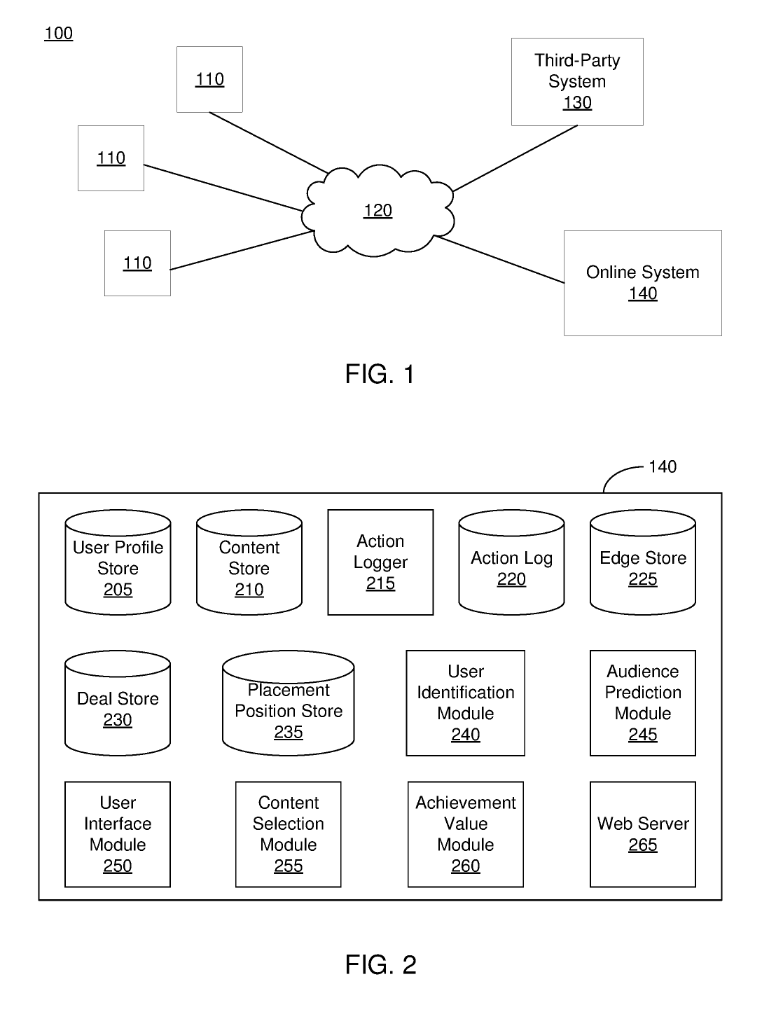

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online system 140. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher) provides content or other information for presentation via a client device 110. A third-party system 130 also may communicate information to the online system 140, such as advertisements, content, or information about an application provided by the third-party system 130.

In some embodiments, the online system 140 (e.g., an online advertising system), which is further described below in conjunction with FIG. 2, offers a “direct sell” of a content item (e.g., an advertisement) to a content-providing user of the online system 140 (e.g., an individual or an entity that provides photos, videos, advertisements, or other content to the online system 140), in which the online system 140 makes a deal with the content-providing user guaranteeing a number of impressions of the content item within a specified time period. For example, the online system 140 may guarantee a content-providing user of the online system 140 who is an advertiser that 10,000 impressions of an advertisement will be achieved within one month. In some embodiments, a direct sell offered by the online system 140 also may guarantee a number of actions associated with a content item. For example, the online system 140 may guarantee a content-providing user of the online system 140 that 500 clicks on a content item or 500 conversions associated with the content item will be achieved within three weeks.

FIG. 2 is a block diagram of an architecture of the online system 140. The online system 140 shown in FIG. 2 includes a user profile store 205, a content store 210, an action logger 215, an action log 220, an edge store 225, a deal store 230, a placement position store 235, a user identification module 240, an audience prediction module 245, a user interface module 250, a content selection module 255, an achievement value module 260, and a web server 265. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

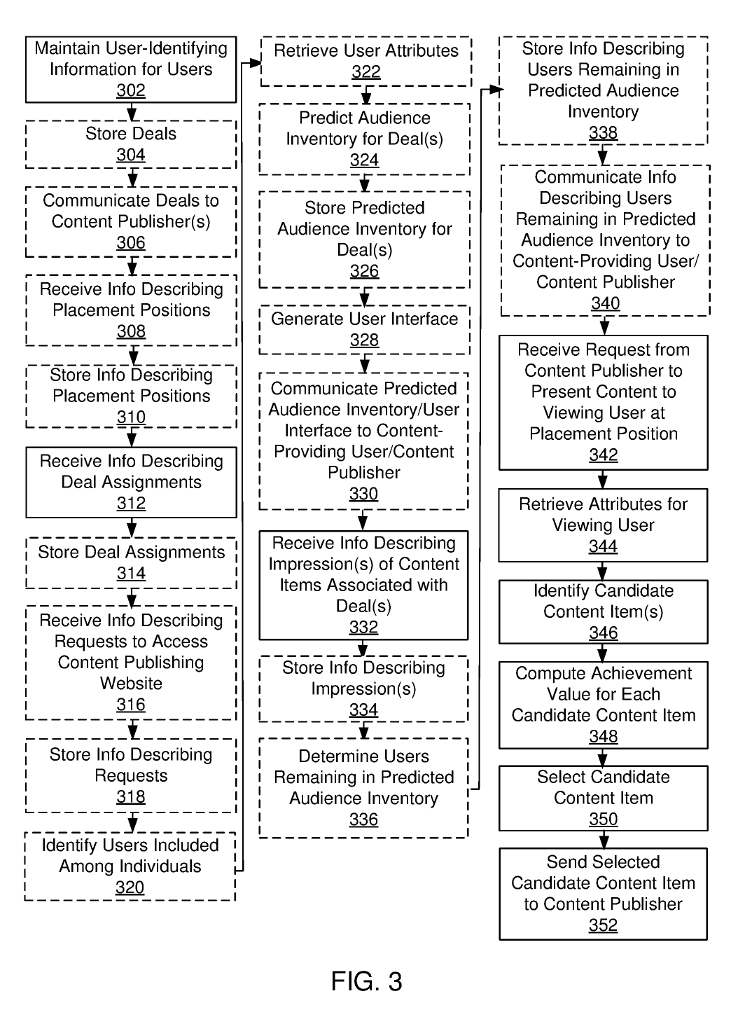

In some embodiments, the user profile store 205 maintains (e.g., as shown in step 302 of FIG. 3) user-identifying information for users of the online system 140. User-identifying information for an online system user may include personally identifiable information. Examples of personally identifiable information include a full name, a home address, a phone number, an email address, a user identifier that is unique to the user in the online system 140 or in a third-party system 130 (e.g., a username, a user identification number, or a cookie identifier), a client device identifier (e.g., an IP address), a browser identifier (e.g., a user agent), etc. In some embodiments, user-identifying information also may include additional types of information that potentially may be combined with other personal information to identify an online system user, such as an age, a gender, a geographic region, etc. For example, user-identifying information for an online system user may include a combination of the user's first name, age, hometown, educational background, and occupation.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

In embodiments in which objects maintained in the content store 210 represent content items that are the subject of one or more deals, the objects may be associated with targeting criteria that specify attributes for online system users who are eligible to be presented with the content items. For example, if a content item is an advertisement for a game application, the online system 140 may target the presentation of the advertisement to viewing users of the online system 140 who are likely to have an interest in the game application based on targeting criteria associated with the advertisement that identify online system users who have installed similar game applications. In this example, an object representing the advertisement may be stored in the content store 210 in association with the targeting criteria.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action logger 215 may receive (e.g., as shown in step 332 of FIG. 3) information describing a request from an individual to be presented with a content item (i.e., an impression of the content item) by a content publisher via a tracking mechanism (e.g., a tracking pixel) embedded into the content item. In some embodiments, a tracking mechanism may be embedded into a content item by a content publisher. For example, prior to presenting one or more content items to individuals who visit a website for a content publisher, the content publisher may embed a tracking pixel into each of the content items. A tracking mechanism may be configured to communicate information to the online system 140 that describes a request received from an individual to be presented with a content item into which the tracking mechanism is embedded.

In some embodiments, information describing a request to be presented with a content item may include user-identifying information for an individual from whom the request was received. User-identifying information may include personally identifiable information or additional types of information that potentially may be combined with other personal information to identify an individual, as described above in conjunction with the user profile store 205. For example, when an individual requests to be presented with a content item in a web page of a website for a content publisher, the action logger 215 may receive information via a tracking pixel that is embedded into the content item that identifies the content item, the web page, and/or the website, the content publisher associated with the web page/website, a client device 110 from which the request was received (e.g., a client device identifier associated with the individual, etc.), and a time at which the request was received.

In embodiments in which the action logger 215 receives information describing requests from individuals to be presented with content items by various content publishers, the action logger 215 may store (e.g., as shown in step 334 of FIG. 3) information describing each request. For example, the action logger 215 may store information describing each request received from an individual to be presented with a content item as an impression achieved by the content item. In this example, the action logger 215 may store this information in the action log 220 or in association with information identifying the content item in the content store 210.

The action logger 215 also may receive (e.g., as shown in step 316 of FIG. 3) information describing a request from an individual to access a web page of a website for a content publisher via a tracking mechanism embedded into the web page. In some embodiments, a tracking mechanism may be embedded into a web page by a content publisher. For example, a content publisher may embed at least one tracking pixel into each web page of a website for the content publisher. In the above example, if a web page of the website for the content publisher is a scrollable web page, the tracking pixels may be embedded into positions within the web page corresponding to different locations within the web page to which an individual may scroll. A tracking mechanism may be configured to communicate information to the online system 140 that describes a request received from an individual to access a web page into which the tracking mechanism has been embedded.

Similar to information describing a request to be presented with a content item, in some embodiments, information describing a request to access a web page may include user-identifying information for an individual from whom the request was received. For example, when an individual requests to access a web page of a website for a content publisher, the action logger 215 receives information via a tracking pixel that is embedded into the web page that identifies the content publisher associated with the web page, the web page that was requested, a client device 110 from which the request was received (e.g., a cookie identifier previously stored in the client device 110 by the online system 140, etc.), and a time at which the request was received.

In embodiments in which the action logger 215 receives information describing requests from individuals to access web pages of websites for various content publishers, the action logger 215 may store (e.g., as shown in step 318 of FIG. 3) information describing each request. For example, the action logger 215 may store information describing each request received from an individual to access a web page of a website for a content publisher. In this example, the action logger 215 may store this information in the action log 220 in association with information identifying the content publisher.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The deal store 230 stores (e.g., as shown in step 304 of FIG. 3) information describing deals between the online system 140 and various content-providing users of the online system 140. A deal may be an agreement between the online system 140 and a content-providing user of the online system 140, in which the online system 140 makes a guarantee associated with a content item. For example, in a deal between the online system 140 and a content-providing user of the online system 140, the online system 140 may guarantee that a number of impressions of a content item will be achieved within a specified time period, in which the content item includes content provided to the online system 140 by the content-providing user.

A deal between the online system 140 and a content-providing user of the online system 140 may be associated with various types of information, including information identifying the deal (e.g., a deal identifier), information identifying the content-providing user of the online system 140, a value associated with the deal provided by the content-providing user (e.g., a budget), a content item associated with the content-providing user of the online system 140 that is the subject of the deal, targeting criteria associated with the content item that specify attributes for online system users who are eligible to be presented with the content item, a value associated with each impression of the content item/each action associated with the content item (e.g., an amount charged to the content-providing user for each impression/action), and a guarantee associated with the content item (e.g., a guaranteed number of impressions of the content item or a guaranteed number of actions associated with the content item within a specified time period). For example, if a deal is made between the online system 140 and a content-providing user of the online system 140 who is an advertiser, the deal may be associated with a deal identification number that uniquely identifies the deal, a budget provided by the advertiser, an advertisement received from the advertiser, targeting criteria associated with the advertisement, an amount charged to the advertiser for each impression of the advertisement, and a guaranteed number of impressions of the advertisement within a time period specified by the advertiser.

One or more deals between the online system 140 and content-providing users of the online system 140 may be assigned by a content publisher to placement positions within web pages of a website for the content publisher. In embodiments in which a content publisher assigns a placement position identifier to each placement position, each deal assigned to a placement position may be associated with a placement position identifier assigned to the placement position. Once a content publisher has assigned one or more deals to a placement position in a website for the content publisher, the content publisher may communicate information describing the assignment(s) to the online system 140.

Upon receiving (e.g., as shown in step 312 of FIG. 3) information describing the assignment of one or more deals to a placement position, the online system 140 may store (e.g., as shown in step 314 of FIG. 3) the information (e.g., in the deal store 230). For example, the online system 140 may store information received from a content publisher in the deal store 230, in which the information indicates that a deal is assigned to a placement position within a website for the content publisher and the placement position is identified by a placement position identifier assigned to the placement position. Information describing deals assigned to placement positions within a website for a content publisher may be stored in the deal store 230 in association with information identifying the content publisher. In the above example, the online system 140 may store the information describing the deal and the placement position identifier in the deal store 230 in association with a name or an identification number associated with the content publisher.

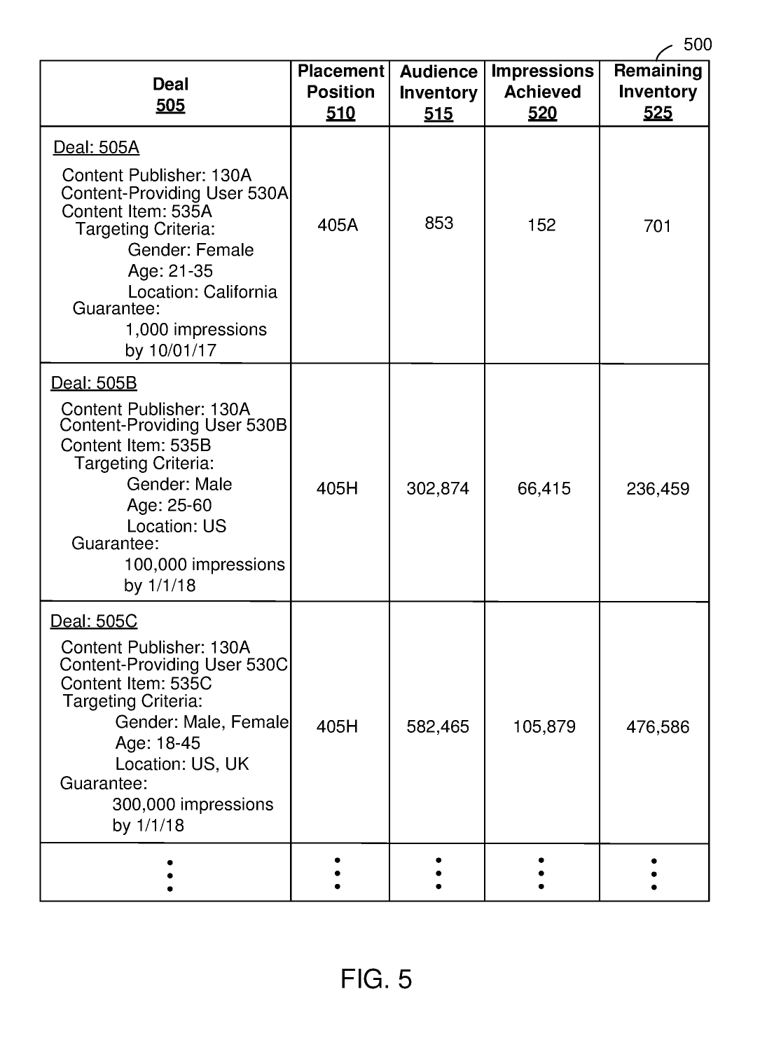

In various embodiments, additional types of information associated with a deal may be stored in the deal store 230. In one embodiment, once the audience prediction module 245 (described below) has predicted an audience inventory associated with a deal, the online system 140 may store (e.g., as shown in step 326 of FIG. 3) the predicted audience inventory in conjunction with additional information describing the deal in the deal store 230. In another embodiment, once the audience prediction module 245 has determined a number of users of the online system 140 to whom a content item associated with a deal has been presented and/or a number of users remaining in an audience inventory predicted for the deal, the audience prediction module 245 may store (e.g., as shown in step 338 of FIG. 3) these number(s) in conjunction with additional information describing the deal in the deal store 230. The deal store 230 is further described below in conjunction with FIGS. 3 and 5.

The placement position store 235 stores (e.g., as shown in step 310 of FIG. 3) information describing placement positions within one or more websites for one or more content publishers. A placement position is a position within a web page of a website for a content publisher that has been designated by the content publisher for the presentation of content items to various individuals (e.g., viewing users of the online system 140). Examples of placement positions within a web page may include positions in a right rail or in a left rail of the web page, rotating positions within a scrollable content unit presented at the top or at the bottom of the web page, positions distributed within an area of the web page where primary content (e.g., the text of an article) may be presented, etc. In some embodiments, a content publisher may assign a placement position identifier to each placement position within a website for the content publisher, in which each placement position identifier uniquely identifies each placement position within the website. For example, each placement position within a website for a content publisher may be associated with a different identification number that corresponds to a placement position identifier.

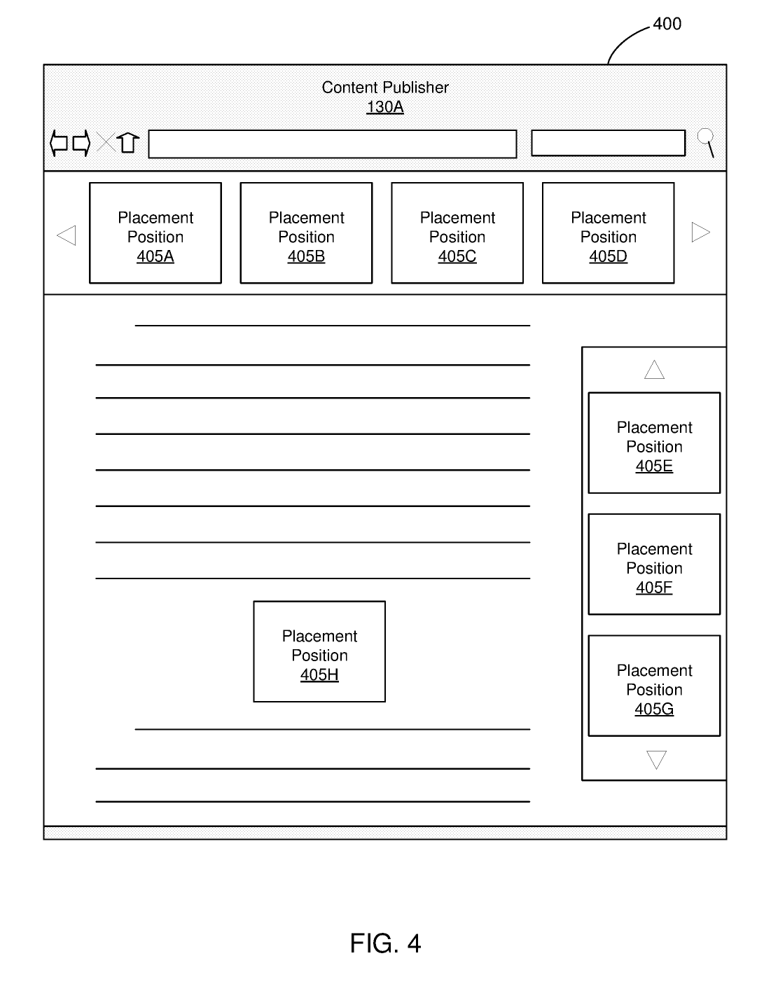

Various types of information may be associated with placement positions within a website for a content publisher. Examples of information associated with placement positions may include information describing a number of placement positions within a website for a content publisher, a placement position identifier associated with each placement position, a location of each placement position relative to other objects within the website, etc. For example, information associated with placement positions within a website for a content publisher may include information that indicates a number of placement positions within the website, a placement position identifier associated with each placement position, and a location of each placement position associated with each placement position identifier. In this example, the location of each placement position may be described in terms of the web page in which the placement position is located and the position of each placement position relative to one or more tracking mechanisms embedded into the web page. In some embodiments, information describing each placement position associated with a content publisher is stored in the placement position store 235 in association with information identifying the content publisher. For example, information describing a placement position associated with a content publisher may be stored in the placement position store 235 in association with a name of the content publisher or a username or a user identification number associated with the content publisher. The placement position store 235 is further described below in conjunction with FIGS. 3 and 4.

The user identification module 240 may identify (e.g., as shown in step 320 of FIG. 3) online system users included among individuals who have requested to access a website for a content publisher. The user identification module 240 may identify online system users included among individuals who have requested to access a website for a content publisher by comparing user-identifying information for the individuals to user-identifying information maintained in the online system 140 for users of the online system 140. For example, suppose that the online system 140 receives information describing a request from an individual to access a web page of a website for a content publisher via a tracking pixel embedded into the web page, in which the information includes a client device identifier associated with the individual. In this example, the user identification module 240 may compare the client device identifier associated with the individual to client device identifiers maintained in the online system 140 for various online system users (e.g., in the user profile store 205). Continuing with this example, the user identification module 240 may identify the individual as an online system user if the client device identifier associated with the individual matches a client device identifier associated with the online system user. The functionality of the user identification module 240 is further described below in conjunction with FIG. 3.

The audience prediction module 245 predicts (e.g., as shown in step 324 of FIG. 3) an audience inventory associated with a deal assigned to a placement position within a website for a content publisher. In some embodiments, the audience prediction module 245 may predict the audience inventory based on information describing the deal, information describing the placement position, and information received via one or more tracking mechanisms embedded into the website. For example, suppose that the online system 140 receives information associated with a deal from a content publisher, in which the deal has been assigned to a placement position within a website for the content publisher and guarantees 1,000 impressions of a content item within one month and targeting criteria associated with the content item identify individuals who are at least 25 years old who live in Texas. In this example, to predict an audience inventory associated with the deal, the audience prediction module 245 may identify a tracking mechanism embedded into a web page in which the placement position is located (e.g., by accessing the deal store 230 and/or the placement position store 235) and retrieve historical data received via the tracking mechanism (e.g., from the action log 220). Continuing with this example, based on the historical data, the audience prediction module 245 may predict an audience inventory associated with the deal by determining a number of requests to access the web page over a period of one month received from online system users who are at least 25 years old and who live in Texas. In some embodiments, the audience prediction module 245 also may predict an audience inventory associated with a deal by determining a number of requests to access a web page of a website for a content publisher received from unique users of the online system 140. For example, the audience prediction module 245 may not count multiple requests to access a web page received from the same online system user when predicting an audience inventory associated with a deal assigned to a placement position located in the web page.

In various embodiments, once the audience prediction module 245 has predicted an audience inventory associated with a deal, the audience prediction module 245 may store (e.g., as shown in step 326 of FIG. 3) the predicted audience inventory. For example, the audience prediction module 245 may store information describing a predicted audience inventory associated with a deal in the deal store 230. In this example, the audience prediction module 245 also may store information describing the predicted audience inventory in the deal store 230 in association with information describing the deal, such as a deal identifier, information identifying a content publisher that has assigned the deal to a placement position within a website for the content publisher, information identifying a content-providing user of the online system 140 with whom the online system 140 has made the deal, a budget associated with the deal, a content item that is the subject of the deal, a guarantee associated with the deal, etc.

In some embodiments, the audience prediction module 245 may determine (e.g., as shown in step 336 of FIG. 3) a number of users of the online system 140 remaining in an audience inventory predicted for a deal. For example, suppose that the audience prediction module 245 predicts an audience inventory of 300 users associated with a deal, in which the online system 140 has guaranteed 200 impressions of a content item associated with the deal within one month and that a content publisher has presented the content item to 70 different users in the first two weeks of the month. In this example, the audience prediction module 245 may determine that of the 200 impressions guaranteed by the content publisher, if 100 have been achieved by 70 users in the predicted audience inventory, there are 230 users remaining in the predicted audience inventory who may achieve the remaining 100 impressions guaranteed by the online system 140. The functionality of the audience prediction module 245 is further described below in conjunction with FIG. 3.

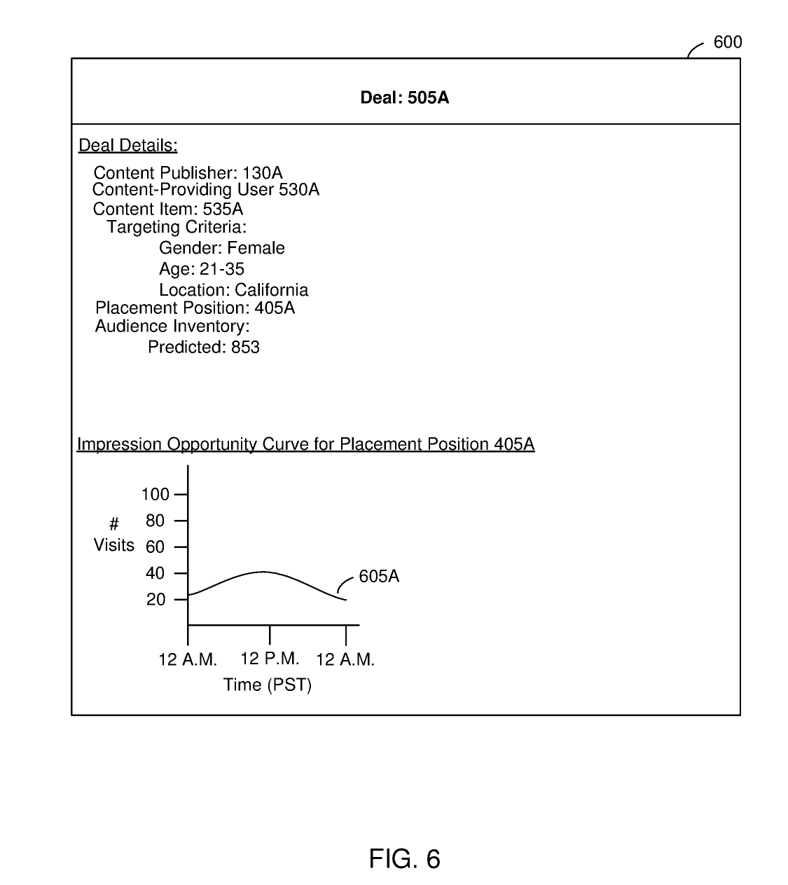

In some embodiments, once the audience prediction module 245 has predicted an audience inventory associated with a deal, the user interface module 250 may generate (e.g., as shown in step 328 of FIG. 3) a user interface based on the prediction. For example, the user interface module 250 may generate a user interface that indicates that the audience prediction module 245 has predicted that an audience inventory associated with a deal includes a particular number of online system users. In various embodiments, the user interface module 250 may generate a user interface that includes an impression opportunity curve associated with a placement position to which a deal has been assigned. In such embodiments, the impression opportunity curve may indicate a number of visits by online system users to a web page including the placement position over a period of time, such that each visit may correspond to an impression achieved by a content item presented in the placement position. For example, the user interface module 250 may generate a user interface including an impression opportunity curve associated with a placement position that describes a number of visits by online system users to a web page of a website for a content publisher over a period of one day, in which each visit will result in an impression of a content item presented in the placement position. In this example, the impression opportunity curve may indicate that the greatest number of visits to the web page occur just before 12:00 PM PST. In various embodiments, an impression opportunity curve associated with a placement position to which a deal has been assigned may correspond to any type of curve that indicates a number of impression opportunities a content publisher will have to present a content item that is the subject of a deal assigned to the placement position over a period of time. For example, an impression opportunity curve may correspond to an integrated curve (e.g., a cumulative sum of a number of visits by online system users to a web page during each hour of a day, ranging from zero to one). The functionality of the user interface module 250 is further described below in conjunction with FIGS. 3 and 6.

Upon receiving a request from a content publisher to present a content item to a viewing user of the online system 140 at a placement position within a website for the content publisher, the content selection module 255 may identify (e.g., as shown in step 346 of FIG. 3) a set of candidate content items eligible to be presented to the viewing user. The content selection module 255 may identify the set of candidate content items based on information identifying the placement position included in the request. For example, based on a placement position identifier received in a request from a content publisher to present a content item to a viewing user of the online system 140, the content selection module 255 may access the deal store 230 and identify multiple deals assigned to the placement position identified by the placement position identifier. In this example, the content selection module 255 may then identify a content item that is the subject of each deal. The content selection module 255 also may identify the set of candidate content items by retrieving (e.g., as shown in step 344 of FIG. 3) a set of attributes associated with the viewing user based on user-identifying information for the viewing user included in the request received from the content publisher. For example, based on a username or an IP address associated with the viewing user, the content selection module 255 may identify the viewing user and retrieve a set of attributes for the viewing user stored in association with a user profile of the viewing user (e.g., in the user profile store 205). Of the content items associated with deals assigned to the placement position specified in the request to present the content item to the viewing user, the content selection module 255 may identify the set of candidate content items as the content items that are associated with targeting criteria satisfied by attributes for the viewing user. For example, once the content selection module 255 has identified content items associated with deals assigned to a placement position identified in a request to present a content item to a viewing user of the online system 140, the content selection module 255 may identify a set of candidate content items, in which each candidate content item is associated with one or more targeting criteria that are satisfied by attributes for the viewing user.

The content selection module 255 also may select (e.g., as shown in step 350 of FIG. 3) a candidate content item for presentation to a viewing user of the online system 140. In some embodiments, the content selection module 255 may select a candidate content item by ranking candidate content items based at least in part on a value associated with each candidate content item and selecting a candidate content item for presentation to a viewing user of the online system 140 based at least in part on the ranking. For example, the content selection module 255 may rank a set of candidate content items based at least in part on a bid amount associated with each candidate content item. In this example, the content selection module 255 may then select the highest ranked candidate content item for presentation to a viewing user of the online system 140.

In some embodiments, a value associated with a candidate content item may correspond to a score computed by the content selection module 255 that indicates a predicted affinity of a viewing user of the online system 140 for the candidate content item. For example, the content selection module 255 may compute an affinity score for each candidate content item eligible for presentation to a viewing user of the online system 140 that indicates a predicted affinity of the viewing user for the candidate content item. In this example, the content selection module 255 may then rank the candidate content items based at least in part on a bid amount and/or the affinity score associated with each candidate content item and select a candidate content item for presentation to the viewing user based at least in part on the ranking.

In various embodiments, a value associated with a candidate content item may correspond to an achievement value computed by the achievement value module 260, which is described below. For example, once the achievement value module 260 has computed an achievement value associated with each candidate content item identified by the content selection module 255, the content selection module 255 ranks the candidate content items based at least in part on the achievement values, such that candidate content items having lower achievement values are ranked higher than candidate content items having higher achievement values. In this example, the content selection module 255 may then select a candidate content item for presentation to a viewing user of the online system 140 based at least in part on the ranking. The functionality of the content selection module 255 is further described below in conjunction with FIG. 3.

For each candidate content item identified by the content selection module 255, the achievement value module 260 may compute (e.g., as shown in step 348 of FIG. 3) an achievement value associated with the candidate content item. The achievement value for a candidate content item may indicate a number of impressions/actions achieved by the candidate content item in relation to a number of impressions/actions guaranteed by the online system 140 in a deal associated with the candidate content item. For example, if a candidate content item has achieved 30 impressions and the online system 140 has guaranteed 100 impressions for the candidate content item, the achievement value module 260 may compute an achievement value for the candidate content item corresponding to a percentage indicating that 30% of the guaranteed impressions have been achieved by the candidate content item. Alternatively, in the above example, the achievement value computed by the achievement value module 260 may correspond to a ratio (e.g., 3:10 or 3/10) associated with the candidate content item, indicating that three out of 10 of the guaranteed impressions have been achieved by the candidate content item.

In some embodiments, achievement values associated with candidate content items also may be computed based at least in part on additional information associated with guarantees associated with the candidate content items. In one embodiment, an achievement value associated with a candidate content item is computed based at least in part on an amount of time remaining for a guarantee associated with the candidate content item to be satisfied. For example, suppose that the achievement value module 260 determines that 20% of the impressions guaranteed by the online system 140 for a first and a second candidate content item have been achieved. In this example, if one week remains for the first candidate content item to achieve the remaining 80% of its impressions and six weeks remain for the second candidate content item to achieve the remaining 80% of its impressions, the achievement value module 260 may associate a weight with each candidate content item that is proportional to the number of weeks remaining, such that a lower weight is associated with the first candidate content item than with the second candidate content item since less time remains for the first candidate content item to satisfy its associated guarantee than for the second candidate content item to satisfy its associated guarantee.

In some embodiments, an achievement value associated with a candidate content item also may be computed based at least in part on a number of guaranteed impressions/actions yet to be achieved. For example, suppose that of 20 impressions guaranteed by the online system 140 for a first candidate content item, 10 have been achieved, and that of 2,000 impressions guaranteed by the online system 140 for a second candidate content item, 1,000 have been achieved. In this example, the achievement value module 260 may associate a weight with each candidate content item that is inversely proportional to the number of impressions remaining, such that a lower weight is associated with the second candidate content item than with the first candidate content item since a greater number of impressions still need to be achieved for the second candidate content item to satisfy its associated guarantee than for the first candidate content item to satisfy its associated guarantee.

In yet another embodiment, an achievement value associated with a candidate content item also may be computed based at least in part on a number of users remaining in an audience inventory predicted for a deal associated with the candidate content item who may satisfy a guarantee associated with the candidate content item. For example, suppose that the audience prediction module 245 has determined that 500 users remain in an audience inventory predicted for a first deal and an audience inventory of 400 users remain in an audience inventory predicted for a second deal, in which the online system 140 has guaranteed 300 impressions of a candidate content item associated with each deal within one month. In this example, the achievement value module 260 may associate a weight with each candidate content item that is proportional to the number of users remaining in the audience inventory predicted for each deal, such that a lower weight is associated with the second candidate content item than with the first candidate content item since fewer users remain for the second candidate content item to satisfy its associated guarantee than for the first candidate content item to satisfy its associated guarantee. In embodiments in which the achievement value module 260 associates a weight with a candidate content item, the achievement value module 260 may compute an achievement value associated with the candidate content item based at least in part on the weight. The functionality of the achievement value module 260 is further described below in conjunction with FIG. 3.

The web server 265 links the online system 140 via the network 120 to the one or more client devices 110, as well as to the third-party system 130 and/or one or more third-party systems 130. The web server 265 serves web pages, as well as other content, such as JAVA®, FLASH®, XML and so forth. The web server 265 may receive and route messages between the online system 140 and the client device 110, for example, instant messages, queued messages (e.g., email), text messages, short message service (SMS) messages, or messages sent using any other suitable messaging technique. A user may send a request to the web server 265 to upload information (e.g., images or videos) that are stored in the content store 210. Additionally, the web server 265 may provide application programming interface (API) functionality to send data directly to native client device operating systems, such as IOS®, ANDROID™, WEBOS® or BlackberryOS.

### Selecting a Content Item for Presentation to an Online System User at a Content Publisher Based on a Guaranteed Number of Impressions of the Content Item

FIG. 3 is a flow chart of a method for selecting a content item for presentation to a user of an online system at a content publisher based on a guaranteed number of impressions of the content item. In other embodiments, the method may include different and/or additional steps than those shown in FIG. 3. Additionally, steps of the method may be performed in a different order than the order described in conjunction with FIG. 3.

The online system 140 may maintain 302 user-identifying information for users of the online system 140 (e.g., in the user profile store 205). User-identifying information for an online system user may include personally identifiable information. Examples of personally identifiable information include a full name, a home address, a phone number, an email address, a user identifier that is unique to the user in the online system 140 or in a third-party system 130 (e.g., a username, a user identification number, or a cookie identifier), a client device identifier (e.g., an IP address), a browser identifier (e.g., a user agent), etc. In some embodiments, user-identifying information also may include additional types of information that potentially may be combined with other personal information to identify an online system user, such as an age, a gender, a geographic region, etc. For example, user-identifying information for an online system user may include a combination of the user's first name, age, hometown, educational background, and occupation.

The online system 140 also may store 304 information describing deals between the online system 140 and various content-providing users of the online system 140 (e.g., in the deal store 230). A deal may be an agreement between the online system 140 and a content-providing user of the online system 140, in which the online system 140 makes a guarantee associated with a content item. For example, in a deal between the online system 140 and a content-providing user of the online system 140, the online system 140 may guarantee that a number of impressions of a content item will be achieved within a specified time period, in which the content item includes content provided to the online system 140 by the content-providing user.

A deal between the online system 140 and a content-providing user of the online system 140 may be associated with various types of information, including information identifying the deal (e.g., a deal identifier), information identifying the content-providing user of the online system 140, a value associated with the deal provided by the content-providing user (e.g., a budget), a content item associated with the content-providing user of the online system 140 that is the subject of the deal, targeting criteria associated with the content item that specify attributes for online system users who are eligible to be presented with the content item, a value associated with each impression of the content item/each action associated with the content item (e.g., an amount charged to the content-providing user for each impression/action), and a guarantee associated with the content item (e.g., a guaranteed number of impressions of the content item or a guaranteed number of actions associated with the content item within a specified time period). For example, if a deal is made between the online system 140 and a content-providing user of the online system 140 who is an advertiser, the deal may be associated with a deal identification number that uniquely identifies the deal, a budget provided by the advertiser, an advertisement received from the advertiser, targeting criteria associated with the advertisement, an amount charged to the advertiser for each impression of the advertisement, and a guaranteed number of impressions of the advertisement within a time period specified by the advertiser.

The online system 140 may communicate 306 information describing deals between the online system 140 and various content-providing users of the online system 140 to various content publishers at which the content items associated with the deals may be presented to viewing users of the online system 140. For example, the online system 140 may communicate 306 various types of information describing a deal between the online system 140 and a content-providing user of the online system 140 to a content publisher, such as information identifying the content-providing user, information identifying a content item associated with the content-providing user that is the subject of the deal, a guaranteed number of impressions of the content item, a time period within which the impressions are guaranteed to be achieved, etc.

The online system 140 may receive 308 information describing placement positions within one or more websites for one or more content publishers. A placement position is a position within a web page of a website for a content publisher that has been designated by the content publisher for the presentation of content items to various individuals (e.g., viewing users of the online system 140). Examples of placement positions within a web page may include positions in a right rail or in a left rail of the web page, rotating positions within a scrollable content unit presented at the top or at the bottom of the web page, positions distributed within an area of the web page where primary content (e.g., the text of an article) may be presented, etc. As shown in the example of FIG. 4, placement positions 405A-405D are rotating positions within a scrollable content unit presented at the top of a web page 400 of a website for a content publisher 130A. Furthermore, placement positions 405E-405G are rotating positions within a scrollable content unit presented in the right rail of the web page 400, while placement position 405H is located within an area of the web page 400 where primary content may be presented. In some embodiments, a content publisher may assign a placement position identifier to each placement position within a website for the content publisher, in which each placement position identifier uniquely identifies each placement position within the website. For example, each placement position within a website for a content publisher may be associated with a different identification number that corresponds to a placement position identifier.

Various types of information may be associated with placement positions within a website for a content publisher. Examples of information associated with placement positions may include information describing a number of placement positions within a website for a content publisher, a placement position identifier associated with each placement position, a location of each placement position relative to other objects within the website, etc. For example, information associated with placement positions within a website for a content publisher may include information that indicates a number of placement positions within the website, a placement position identifier associated with each placement position, and a location of each placement position associated with each placement position identifier. In this example, the location of each placement position may be described in terms of the web page in which the placement position is located and the position of each placement position relative to one or more tracking mechanisms embedded into the web page.

Referring back to FIG. 3, the online system 140 may store 310 information describing each placement position within a website for a content publisher (e.g., in the placement position store 235). In some embodiments, information describing each placement position associated with a content publisher is stored 310 in association with information identifying the content publisher. For example, information describing a placement position associated with a content publisher may be stored 310 in association with a name of the content publisher or a username or a user identification number associated with the content publisher.

One or more deals between the online system 140 and one or more content-providing users of the online system 140 may be assigned by a content publisher to placement positions within web pages of a website for the content publisher. In embodiments in which a content publisher assigns a placement position identifier to each placement position, each deal assigned to a placement position may be associated with a placement position identifier assigned to the placement position. Once a content publisher has assigned one or more deals to a placement position in a website for the content publisher, the content publisher may communicate information describing the assignment(s) to the online system 140.

Upon receiving 312 information describing the assignment of one or more deals to a placement position, the online system 140 may store 314 the information (e.g., in the deal store 230). For example, the online system 140 may store 314 information received 312 from a content publisher in the deal store 230, in which the information indicates that a deal is assigned to a placement position within a website for the content publisher and the placement position is identified by a placement position identifier assigned to the placement position. Information describing deals assigned to placement positions within a website for a content publisher may be stored 314 in association with information identifying the content publisher. In the above example, the online system 140 may store 314 the information describing the deal and the placement position identifier in the deal store 230 in association with a name or an identification number associated with the content publisher.

As shown in the example of FIG. 5, the online system 140 may store 314 information describing various deals 505 in a table 500 (e.g., in the deal store 230). Information describing each deal 505 may include information identifying a content publisher 130 having a website including a placement position 510 to which the deal 505 has been assigned and the content-providing user 530 of the online system 140 with whom the online system 140 has made the deal 505, a content item 535 associated with the deal 505, targeting criteria associated with the content item 535, and a guarantee associated with the content item 535. Information stored 314 in the table 500 also may include information identifying each placement position 510 to which each deal 505 has been assigned. For example, the column of placement positions 510 in the table 500 indicate that deal 505A has been assigned to placement position 405A, while deal 505B and 505C have been assigned to placement position 405H.

Referring again to FIG. 3, the online system 140 may receive 316 (e.g., using the action logger 215) information describing requests to access a website for a content publisher. The online system 140 may receive 316 information describing a request from an individual to access a web page of a website for a content publisher via a tracking mechanism (e.g., a tracking pixel) embedded into the web page. In some embodiments, a tracking mechanism may be embedded into a web page by a content publisher. For example, a content publisher may embed at least one tracking pixel into each web page of a website for the content publisher. In the above example, if a web page of the website for the content publisher is a scrollable web page, the tracking pixels may be embedded into positions within the web page corresponding to different locations within the web page to which an individual may scroll. A tracking mechanism may be configured to communicate information to the online system 140 that describes a request from the individual to access a web page into which the tracking mechanism has been embedded.

In some embodiments, information describing a request to access a web page may include user-identifying information for an individual from whom the request was received 316. For example, when an individual requests to access a web page of a website for a content publisher, the online system 140 receives 316 information via a tracking pixel that is embedded into the web page that identifies the content publisher associated with the web page, the web page that was requested, a client device 110 from which the request was received 316 (e.g., a cookie identifier previously stored in the client device 110 by the online system 140, etc.), and a time at which the request was received 316.

In embodiments in which the online system 140 receives 316 information describing requests from individuals to access web pages of websites for various content publishers, the online system 140 may store 318 (e.g., using the action logger 215) information describing each request. For example, the online system 140 may store 318 information describing each request received 316 from an individual to access a web page of a website for a content publisher in the action log 220 in association with information identifying the content publisher.

The online system 140 may identify 320 (e.g., using the user identification module 240) one or more online system users included among the individuals who have requested to access the web pages of the websites for the content publishers. The online system 140 may identify 320 the online system users by comparing user-identifying information for the individuals to user-identifying information maintained 302 in the online system 140 for users of the online system 140. For example, suppose that the online system 140 receives 316 information describing a request from an individual to access a web page of a website for a content publisher via a tracking pixel embedded into the web page, in which the information includes a client device identifier associated with the individual. In this example, the online system 140 may compare the client device identifier associated with the individual to client device identifiers maintained 302 in the online system 140 for various online system users (e.g., in the user profile store 205). Continuing with this example, the online system 140 may identify 320 the individual as an online system user if the client device identifier associated with the individual matches a client device identifier associated with the online system user.

In some embodiments, once the online system 140 has identified 320 online system users included among individuals who have requested to access a website for a content publisher, the online system 140 may retrieve 322 various attributes for the online system users. Examples of attributes for an online system user include demographic information for the user (e.g., age, gender, etc.), interests or hobbies of the user, information describing actions previously performed by the user (e.g., clicks on various content items) in the online system 140 or in a third-party system 130, or any other suitable characteristic that may be associated with the user. The online system 140 may retrieve 322 a set of attributes maintained in the online system 140 for each unique online system user who has requested to access a website. For example, if the online system 140 has identified 320 each unique online system user included among individuals who have requested to access a website for a content publisher, the online system 140 may retrieve 322 a set of attributes stored in association with a user profile of each user maintained in the online system 140.

In some embodiments, the online system 140 may predict 324 (e.g., using the audience prediction module 245) an audience inventory associated with a deal assigned to a placement position within a website for a content publisher. The online system 140 may predict 324 the audience inventory based on information describing the deal, information describing the placement position, and information received 316 via one or more tracking mechanisms embedded into the website. For example, suppose that the online system 140 receives 312 information associated with a deal from a content publisher, in which the deal has been assigned to a placement position within a website for the content publisher and guarantees 1,000 impressions of a content item within one month and targeting criteria associated with the content item identify individuals who are at least 25 years old who live in Texas. In this example, to predict 324 an audience inventory associated with the deal, the online system 140 may identify a tracking mechanism embedded into a web page in which the placement position is located (e.g., by accessing the deal store 230 and/or the placement position store 235) and retrieve historical data received 316 via the tracking mechanism (e.g., from the action log). Continuing with this example, based on the historical data, the online system 140 may predict 324 an audience inventory associated with the deal by determining a number of requests to access the web page over a period of one month received 316 from online system users who are at least 25 years old and who live in Texas. In some embodiments, the online system 140 also may predict 324 an audience inventory associated with a deal by determining a number of requests to access a web page of a website for a content publisher received 316 from unique users of the online system 140. For example, the online system 140 may not count multiple requests to access a web page received 316 from the same online system user when predicting 324 an audience inventory associated with a deal assigned to a placement position located in the web page.

In various embodiments, once the online system 140 has predicted 324 an audience inventory associated with a deal, the online system 140 may store 326 the predicted audience inventory (e.g., in the deal store 230). For example, the online system 140 may store 326 information describing a predicted audience inventory associated with a deal in the deal store 230. In this example, the online system 140 may store 326 information describing the predicted audience inventory in the deal store 230 in association with information describing the deal, such as a deal identifier, information identifying a content publisher that has assigned the deal to a placement position within a website for the content publisher, a content-providing user of the online system 140 with whom the online system 140 has made the deal, a budget associated with the deal, a content item that is the subject of the deal, a guarantee associated with the deal, etc. Referring again to FIG. 5, information stored 304 in the table 500 describing various deals 505 also may include information describing an audience inventory 515 predicted 324 for each deal 505.

Referring back to FIG. 3, in some embodiments, once the online system 140 has predicted 324 an audience inventory associated with a deal, the online system 140 also may generate 328 (e.g., using the user interface module 250) a user interface based on the prediction. In some embodiments, the online system 140 may generate 328 a user interface that indicates a number of online system users included in the audience inventory. As shown in the example of FIG. 6, a user interface 600 generated 328 by the online system 140 indicates that an audience inventory predicted 324 for deal 505A includes 853 users of the online system 140. In various embodiments, the online system 140 may generate 328 an impression opportunity curve associated with a placement position to which a deal has been assigned. In such embodiments, the impression opportunity curve may indicate a number of visits by online system users to a web page of a website for a content publisher over a period of time, in which a content item presented in the placement position may achieve an impression. FIG. 6 also depicts an impression opportunity curve 605A associated with the placement position 405A to which deal 505A has been assigned. The impression opportunity curve 605A indicates a number of visits by online system users to a web page of a website of a content publisher 130A over a period of one day, in which a content item 505 presented in the placement position 405A may achieve an impression upon each visit. As shown in the impression opportunity curve 605A, the greatest number of visits to the web page occur just before 12:00 PM PST. In various embodiments, an impression opportunity curve associated with a placement position to which a deal has been assigned may correspond to any type of curve that indicates a number of impression opportunities a content publisher will have to present a content item that is the subject of a deal assigned to the placement position over a period of time. For example, an impression opportunity curve may correspond to an integrated curve (e.g., a cumulative sum of a number of visits by online system users to a web page during each hour of a day, ranging from zero to one).

Referring back to FIG. 3, the online system 140 may communicate 330 a predicted audience inventory associated with a deal and/or a user interface based on the predicted audience inventory to a content-providing user of the online system 140 with whom the online system 140 has made the deal and/or to a content publisher that has assigned the deal to a placement position within a website for the content publisher. For example, if the online system 140 predicts 324 an audience inventory associated with a deal, in which the deal is between the online system 140 and a particular content-providing user of the online system 140, the online system 140 may communicate 330 the predicted audience inventory to the content-providing user of the online system 140. In the above example, if the online system 140 generates 328 a diagram based on the predicted audience inventory, the online system 140 also may communicate 330 the diagram to the content-providing user of the online system 140.

The online system 140 may receive 332 (e.g., using the action logger 215) information describing impressions achieved by content items presented to individuals by one or more content publishers (i.e., information describing requests to be presented with the content items from the individuals). The online system 140 may receive 332 information describing an impression achieved by a content item presented by a content publisher via a tracking mechanism (e.g., a tracking pixel) embedded into the content item. In some embodiments, a tracking mechanism may be embedded into a content item by a content publisher. For example, prior to presenting one or more content items to individuals who visit a website for a content publisher, the content publisher may embed a tracking pixel into each of the content items. A tracking mechanism may be configured to communicate information to the online system 140 that describes a request from an individual to be presented with a content item into which the tracking mechanism is embedded.

In some embodiments, information describing a request to be presented with a content item may include user-identifying information for an individual from whom the request was received 332. User-identifying information may include personally identifiable information or additional types of information that potentially may be combined with other personal information to identify an individual, as described above. For example, when an individual requests to be presented with a content item in a placement position of a web page of a website for a content publisher, the online system 140 may receive 332 information via a tracking pixel that is embedded into the content item that identifies the content item, the web page and/or the website, the content publisher associated with the web page/website, a client device 110 from which the request was received 332 (e.g., a client device identifier associated with the individual, etc.), and a time at which the request was received 332.

In embodiments in which the online system 140 receives 332 information describing impressions achieved by content items presented to individuals by one or more content publishers, the online system 140 may store 334 (e.g., using the action logger 215) information describing each impression. For example, the online system 140 may store 334 information describing each request received 332 from an individual to be presented with a content item as an impression achieved by the content item. In this example, the online system 140 may store 334 this information in the action log 220 or in association with information identifying the content item in the content store 210.

In some embodiments, the online system 140 may determine 336 (e.g., using the audience prediction module 245) a number of online system users remaining in a predicted audience inventory associated with a deal. For example, suppose that the online system 140 predicts 324 an audience inventory of 300 users associated with a deal, in which the online system 140 has guaranteed 200 impressions of a content item associated with the deal within one month and that a content publisher has presented the content item to 70 different users in the first two weeks of the month. In this example, the online system 140 may determine 336 that of the 200 impressions guaranteed by the online system 140, if 70 have been achieved by 70 users in the predicted audience inventory, there are 230 users remaining in the predicted audience inventory who may achieve the remaining 130 impressions guaranteed by the online system 140.

In some embodiments, the online system 140 may store 338 (e.g., using the audience prediction module 245) information describing a number of online system users remaining in an audience inventory associated with a deal (e.g., in the deal store 230). As shown in the example of FIG. 5, information stored 304 in the table 500 describing various deals 505 also may include a number of impressions achieved 520 by each content item 535 associated with each deal 505 and a number of online system users remaining in the audience inventory 525 associated with each deal 505.

Referring back to FIG. 3, the online system 140 may communicate 340 information describing online system users remaining in an audience inventory associated with a deal to a content-providing user of the online system 140 with whom the online system 140 has made the deal and/or to a content publisher that has assigned the deal to a placement position within a website for the content publisher. For example, the online system 140 may communicate 340 information to a content-providing user of the online system 140 describing a number of online system users included in an audience inventory associated with a deal, a number of online system users to whom a content item that is the subject of the deal has been presented, and a number of online system users remaining in the audience inventory to whom the content item has not been presented.

The online system 140 may receive 342 a request from a content publisher to present content to a viewing user of the online system 140 at a placement position within a website for the content publisher. The request to present content to the viewing user may include user-identifying information for the user. For example, the request may include personally identifiable information or additional types of information that potentially may be combined to identify the viewing user. The request to present content to the viewing user also may include information identifying the placement position within the website for the content publisher. For example, the request may include a placement position identifier assigned to the placement position by the content publisher.

Upon receiving 342 the request to present content to the viewing user, the online system 140 may identify 346 (e.g., using the content selection module 255) a set of candidate content items eligible to be presented to the viewing user based on information identifying the placement position and user-identifying information for the viewing user included in the request. To identify 346 the set of candidate content items, the online system 140 may first retrieve 344 (e.g., using the content selection module 255) a set of attributes for the viewing user. The online system 140 may retrieve 344 the set of attributes associated with the viewing user based on the user-identifying information for the viewing user included in the request. For example, based on a username or an IP address associated with the viewing user, the online system 140 may identify the viewing user and retrieve 344 a set of attributes for the viewing user stored in association with a user profile of the viewing user. The online system 140 may then identify one or more deals assigned to the placement position specified in the request received 342 from the content publisher and a set of content items associated with each deal. For example, based on a placement position identifier received 342 in a request from a content publisher to present a content item to a viewing user of the online system 140, the online system 140 may access the deal store 230 and identify multiple deals assigned to the placement position identified by the placement position identifier. In this example, the online system 140 may then identify a content item associated with each deal.

Of the content items associated with deals assigned to the placement position specified in the request to present content to the viewing user, the online system 140 may identify 346 the set of candidate content items as the content items that are associated with targeting criteria satisfied by attributes for the viewing user. For example, once the online system 140 has identified content items associated with deals assigned to a placement position identified in a request to present content to a viewing user of the online system 140, the online system 140 may identify 346 a set of candidate content items, in which each candidate content item is associated with one or more targeting criteria that are satisfied by attributes for the viewing user.

For each candidate content item identified 346 by the online system 140, the online system 140 may compute 348 (e.g., using the achievement value module 260) an achievement value associated with the candidate content item. The achievement value for a candidate content item may indicate a number of impressions/actions achieved by the candidate content item in relation to a number of impressions/actions guaranteed by the online system 140 in a deal associated with the candidate content item. For example, if a candidate content item has achieved 30 impressions and the online system 140 has guaranteed 100 impressions for the candidate content item, the online system 140 may compute 348 an achievement value for the candidate content item corresponding to a percentage indicating that 30% of the guaranteed impressions have been achieved by the candidate content item. Alternatively, in the above example, the achievement value computed 348 by the online system 140 may correspond to a ratio (e.g., 3:10 or 3/10) associated with the candidate content item, indicating that three out of 10 of the guaranteed impressions have been achieved by the candidate content item.

In some embodiments, achievement values associated with candidate content items also may be computed 348 based at least in part on additional information associated with guarantees associated with the candidate content items. In one embodiment, an achievement value associated with a candidate content item is computed 348 based at least in part on an amount of time remaining for a guarantee associated with the candidate content item to be satisfied. For example, suppose that the online system 140 determines that 20% of the impressions guaranteed by the online system 140 for a first and a second candidate content item have been achieved. In this example, if one week remains for the first candidate content item to achieve the remaining 80% of its impressions and six weeks remain for the second candidate content item to achieve the remaining 80% of its impressions, the online system 140 may associate a weight with each candidate content item that is proportional to the number of weeks remaining, such that a lower weight is associated with the first candidate content item than with the second candidate content item since less time remains for the first candidate content item to satisfy its associated guarantee than for the second candidate content item to satisfy its associated guarantee.

In some embodiments, an achievement value associated with a candidate content item also may be computed 348 based at least in part on a number of guaranteed impressions/actions yet to be achieved. For example, suppose that of 20 impressions guaranteed by the online system 140 for a first candidate content item, 10 have been achieved, and that of 2,000 impressions guaranteed by the online system 140 for a second candidate content item, 1,000 have been achieved. In this example, the online system 140 may associate a weight with each candidate content item that is inversely proportional to the number of impressions remaining, such that a lower weight is associated with the second candidate content item than with the first candidate content item since a greater number of impressions still need to be achieved for the second candidate content item to satisfy its associated guarantee than for the first candidate content item to satisfy its associated guarantee.

In yet another embodiment, an achievement value associated with a candidate content item also may be computed 348 based at least in part on a number of users remaining in an audience inventory predicted 324 for a deal associated with the candidate content item who may satisfy a guarantee associated with the candidate content item. For example, suppose that the online system 140 has determined 336 that 500 users remain in an audience inventory predicted 324 for a first deal and an audience inventory of 400 users remain in an audience inventory predicted 324 for a second deal, in which the online system 140 has guaranteed 300 impressions of a candidate content item associated with each deal within one month. In this example, the online system 140 may associate a weight with each candidate content item that is proportional to the number of users remaining in the audience inventory predicted 324 for each deal, such that a lower weight is associated with the second candidate content item than with the first candidate content item since fewer users remain for the second candidate content item to satisfy its associated guarantee than for the first candidate content item to satisfy its associated guarantee. In embodiments in which the online system 140 associates a weight with a candidate content item, the online system 140 may compute 348 an achievement value associated with the candidate content item based at least in part on the weight.

The online system 140 may select 350 (e.g., using the content selection module 255) a candidate content item for presentation to the viewing user of the online system 140. In some embodiments, the online system 140 may select 350 the candidate content item by ranking the candidate content items based at least in part on a value associated with each candidate content item and selecting 350 a candidate content item for presentation to the viewing user based at least in part on the ranking. For example, the online system 140 may rank a set of candidate content items based at least in part on a bid amount associated with each candidate content item. In this example, the online system 140 may then select 350 the highest ranked candidate content item for presentation to a viewing user of the online system 140 based at least in part on the ranking.

In some embodiments, a value associated with a candidate content item may correspond to a score computed by the online system 140 that indicates a predicted affinity of the viewing user of the online system 140 for the candidate content item. For example, the online system 140 may compute an affinity score for each candidate content item eligible for presentation to a viewing user of the online system 140 that indicates a predicted affinity of the viewing user for the candidate content item. In this example, the online system 140 may then rank the candidate content items based at least in part on a bid amount and/or the affinity score associated with each candidate content item and select 350 a candidate content item for presentation to the viewing user based at least in part on the ranking.

In various embodiments, a value associated with a candidate content item may correspond to an achievement value. For example, once the online system 140 has computed 348 an achievement value associated with each candidate content item identified 346 by the online system 140, the online system 140 ranks the candidate content items based at least in part on the achievement values, such that candidate content items having lower achievement values are ranked higher than candidate content items having higher achievement values. In this example, the online system 140 may then select 350 a highest ranked candidate content item for presentation to a viewing user of the online system 140.

Once the online system 140 has selected 350 a candidate content item for presentation to the viewing user of the online system 140, the online system 140 may send 352 the selected 350 candidate content item to the content publisher for presentation to the viewing user at the placement position. The content publisher may then present the content item to the viewing user at the placement position.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a set of information from a content publisher describing one or more deals assigned to a placement position within a website for the content publisher, each of the one or more deals associated with a content item, a set of targeting criteria associated with the content item, and a guaranteed number of impressions of the content item within a specified time period;
receiving an additional set of information describing impressions achieved by the content item associated with each of the one or more deals;
receiving a request from the content publisher to present content to a viewing user of the online system at the placement position, the request comprising user-identifying information for the viewing user;
retrieving a set of attributes for the viewing user maintained in the online system based at least in part on the user-identifying information for the viewing user;
identifying a set of candidate content items eligible for presentation to the viewing user, wherein the set of candidate content items is associated with a set of the one or more deals and each of the set of candidate content items is associated with targeting criteria satisfied by the set of attributes for the viewing user;
computing an achievement value associated with each of the set of candidate content items based at least in part on the set of information describing the one or more deals and on the additional set of information describing impressions achieved by the content item associated with each of the one or more deals, the achievement value indicating a number of impressions achieved by the candidate content item in relation to the guaranteed number of impressions of the candidate content item within the specified time period;
selecting a candidate content item of the set of candidate content items based at least in part on the achievement value associated with each of the set of candidate content items; and
sending the selected candidate content item to the content publisher for display to the viewing user.

2. The method of claim 1, wherein computing the achievement value associated with each of the set of candidate content items further comprises:
determining a difference between a current time and an end of the specified time period associated with each of the set of deals;
determining a weight associated with each of the set of candidate content items based at least in part on the difference associated with a corresponding deal; and
computing the achievement value associated with each of the set of candidate content items based at least in part on the weight.

3. The method of claim 1, wherein computing the achievement value associated with each of the set of candidate content items further comprises:
determining a number of impressions achieved by each of the candidate content items based at least in part on the additional set of information describing impressions achieved by the content item associated with each of the one or more deals;
determining a difference between the number of impressions achieved by each of the candidate content items and the guaranteed number of impressions of the candidate content item associated with each of the set of deals;
determining a weight associated with each of the set of candidate content items based at least in part on the difference; and
computing the achievement value associated with each of the set of candidate content items based at least in part on the weight.

4. The method of claim 1, further comprising:
receiving information describing a plurality of requests received from one or more individuals to access the website for the content publisher via one or more tracking mechanisms embedded into one or more web pages of the website for the content publisher, each of the plurality of requests comprising a set of user-identifying information for each of the one or more individuals from whom each of the plurality of requests is received;
comparing the set of user-identifying information for each of the one or more individuals to an additional set of user-identifying information maintained in the online system for one or more users of the online system;
identifying a set of users of the online system among the one or more individuals based at least in part on the comparing;
retrieving an additional set of attributes associated with the identified set of users of the online system; and
predicting an audience inventory associated with each of the one or more deals based at least in part on the retrieved additional set of attributes associated with the identified set of users of the online system and on the set of targeting criteria associated with each of the one or more deals.

5. The method of claim 4, wherein predicting the audience inventory associated with each of the one or more deals is further based at least in part on a number of unique users of the online system among the identified set of users of the online system.

6. The method of claim 4, further comprising:
determining a number of viewing users of the online system to whom each content item associated with each of the one or more deals has been presented based at least in part on the additional set of information describing impressions achieved by the content item associated with each of the one or more deals;
determining a difference between the audience inventory associated with each of the one or more deals and the number of viewing users of the online system to whom each content item associated with each of the one or more deals has been presented; and
communicating the difference to the content publisher.

7. The method of claim 4, where in the one or more tracking mechanisms embedded into one or more web pages of the website for the content publisher comprise one or more tracking pixels.

8. The method of claim 1, further comprising:
determining a number of viewing users of the online system to whom each content item associated with each of the one or more deals has been presented based at least in part on the additional set of information describing impressions achieved by the content item associated with each of the one or more deals;
generating an impression opportunity curve associated with each of the one or more deals based at least in part on the determined number of viewing users of the online system to whom each content item associated with each of the one or more deals has been presented, the impression opportunity curve predicting a number of impression opportunities the content publisher will have to present each content item associated with each of the one or more deals assigned to the placement position over the specified time period; and
communicating the impression opportunity curve to the content publisher.

9. The method of claim 1, wherein the request from the content publisher to present content to the viewing user of the online system at the placement position comprises a placement position identifier assigned to the placement position by the content publisher.

10. The method of claim 1, wherein the achievement value associated with each of the set of candidate content items comprises a percentage of the guaranteed number of impressions of the candidate content item that have been achieved.

11. The method of claim 1, wherein the achievement value associated with each of the set of candidate content items comprises a ratio of a number of impressions achieved by the candidate content item to the guaranteed number of impressions of the candidate content item.

12. A computer program product comprising a computer readable storage medium having instructions encoded thereon that, when executed by a processor, cause the processor to:
receive, at an online system, a set of information from a content publisher describing one or more deals assigned to a placement position within a website for the content publisher, each of the one or more deals associated with a content item, a set of targeting criteria associated with the content item, and a guaranteed number of impressions of the content item within a specified time period;
receive an additional set of information describing impressions achieved by the content item associated with each of the one or more deals;
receive a request from the content publisher to present content to a viewing user of the online system at the placement position, the request comprising user-identifying information for the viewing user;
retrieve a set of attributes for the viewing user maintained in the online system based at least in part on the user-identifying information for the viewing user;
identify a set of candidate content items eligible for presentation to the viewing user, wherein the set of candidate content items is associated with a set of the one or more deals and each of the set of candidate content items is associated with targeting criteria satisfied by the set of attributes for the viewing user;
compute an achievement value associated with each of the set of candidate content items based at least in part on the set of information describing the one or more deals and on the additional set of information describing impressions achieved by the content item associated with each of the one or more deals, the achievement value indicating a number of impressions achieved by the candidate content item in relation to the guaranteed number of impressions of the candidate content item within the specified time period;
select a candidate content item of the set of candidate content items based at least in part on the achievement value associated with each of the set of candidate content items; and
send the selected candidate content item to the content publisher for display to the viewing user.

13. The computer program product of claim 12, wherein compute the achievement value associated with each of the set of candidate content items further comprises:
determine a difference between a current time and an end of the specified time period associated with each of the set of deals;
determine a weight associated with each of the set of candidate content items based at least in part on the difference associated with a corresponding deal; and
compute the achievement value associated with each of the set of candidate content items based at least in part on the weight.

14. The computer program product of claim 12, wherein compute the achievement value associated with each of the set of candidate content items further comprises:
determine a number of impressions achieved by each of the candidate content items based at least in part on the additional set of information describing impressions achieved by the content item associated with each of the one or more deals;
determine a difference between the number of impressions achieved by each of the candidate content items and the guaranteed number of impressions of the candidate content item associated with each of the set of deals;
determine a weight associated with each of the set of candidate content items based at least in part on the difference; and
compute the achievement value associated with each of the set of candidate content items based at least in part on the weight.

15. The computer program product of claim 12, wherein the computer readable storage medium further has instructions encoded thereon that, when executed by the processor, cause the processor to:
receive information describing a plurality of requests received from one or more individuals to access the website for the content publisher via one or more tracking mechanisms embedded into one or more web pages of the website for the content publisher, each of the plurality of requests comprising a set of user-identifying information for each of the one or more individuals from whom each of the plurality of requests is received;
compare the set of user-identifying information for each of the one or more individuals to an additional set of user-identifying information maintained in the online system for one or more users of the online system;
identify a set of users of the online system among the one or more individuals based at least in part on the comparing;
retrieve an additional set of attributes associated with the identified set of users of the online system; and
predict an audience inventory associated with each of the one or more deals based at least in part on the retrieved additional set of attributes associated with the identified set of users of the online system and on the set of targeting criteria associated with each of the one or more deals.

16. The computer program product of claim 15, wherein predict the audience inventory associated with each of the one or more deals is further based at least in part on a number of unique users of the online system among the identified set of users of the online system.

17. The computer program product of claim 15, wherein the computer readable storage medium further has instructions encoded thereon that, when executed by the processor, cause the processor to:
determine a number of viewing users of the online system to whom each content item associated with each of the one or more deals has been presented based at least in part on the additional set of information describing impressions achieved by the content item associated with each of the one or more deals;
determine a difference between the audience inventory associated with each of the one or more deals and the number of viewing users of the online system to whom each content item associated with each of the one or more deals has been presented; and
communicate the difference to the content publisher.

18. The computer program product of claim 15, where in the one or more tracking mechanisms embedded into one or more web pages of the website for the content publisher comprise one or more tracking pixels.

19. The computer program product of claim 12, wherein the computer readable storage medium further has instructions encoded thereon that, when executed by the processor, cause the processor to:
determine a number of viewing users of the online system to whom each content item associated with each of the one or more deals has been presented based at least in part on the additional set of information describing impressions achieved by the content item associated with each of the one or more deals;
generate an impression opportunity curve associated with each of the one or more deals based at least in part on the determined number of viewing users of the online system to whom each content item associated with each of the one or more deals has been presented, the impression opportunity curve predicting a number of impression opportunities the content publisher will have to present each content item associated with each of the one or more deals assigned to the placement position over the specified time period; and
communicate the impression opportunity curve to the content publisher.

20. The computer program product of claim 12, wherein the request from the content publisher to present content to the viewing user of the online system at the placement position comprises a placement position identifier assigned to the placement position by the content publisher.

21. The computer program product of claim 12, wherein the achievement value associated with each of the set of candidate content items comprises a percentage of the guaranteed number of impressions of the candidate content item that have been achieved.

22. The computer program product of claim 12, wherein the achievement value associated with each of the set of candidate content items comprises a ratio of a number of impressions achieved by the candidate content item to the guaranteed number of impressions of the candidate content item.

23. A method comprising:
receiving, at an online system, a set of information from a content publisher describing one or more deals assigned to a placement position within a website for the content publisher, each of the one or more deals associated with a content item, a set of targeting criteria associated with the content item, and a guarantee associated with the content item;
receiving an additional set of information describing one or more requests received by the content publisher, each of the one or more requests associated with a set of content items associated with the one or more deals;
receiving a request from the content publisher to present content to a viewing user of the online system at the placement position, the request comprising user-identifying information for the viewing user;
retrieving a set of attributes for the viewing user maintained in the online system based at least in part on the user-identifying information for the viewing user;
identifying a set of candidate content items eligible for presentation to the viewing user based at least in part on the set of targeting criteria associated with each of the set of candidate content items and on the set of attributes for the viewing user, the set of candidate content items associated with a set of the one or more deals;
computing an achievement value associated with each of the set of candidate content items based at least in part on the set of information describing the one or more deals and on the additional set of information describing the one or more requests received by the content publisher, the achievement value indicating a number of requests associated with each candidate content item in relation to the guarantee associated with each candidate content item;
selecting a candidate content item based at least in part on the achievement value associated with each of the set of candidate content items; and
sending the selected candidate content item to the content publisher for display to the viewing user.

24. The method of claim 23, wherein the guarantee associated with the content item comprises a guaranteed number of impressions of the content item within a specified time period or a guaranteed number of requests to perform an action associated with the content item within the specified time period.

25. The method of claim 23, wherein selecting the candidate content item based at least in part on the achievement value associated with each of the set of candidate content items comprises:
ranking the set of candidate content items based at least in part on the achievement value associated with each of the set of candidate content items; and
selecting the candidate content item based at least in part on the ranking.
